(19) United States
(12) Patent Application Publication
(10) Pub. No.: US 2026/0338236 A1
(43) Pub. Date: Oct. 29, 2026

(54) MULTI-STAGE VIBRATION DAMPING APPARATUS HAVING HYSTERESIS REGULATING MEANS

(71) Applicant: Valeo Kapec Co., Ltd., Daegu (KR)

(72) Inventors: Junghyuck KIM, Daegu (KR); Jungwoo KIM, Daegu (KR); Jin-Su PARK, Daegu (KR); Aron JO, Daegu (KR)

(73) Assignee: Valeo Kapec Co., Ltd., Daegu (KR)

(21) Appl. No.: 19/142,836

(22) PCT Filed: Dec. 1, 2023
(86) PCT No.: PCT/KR2023/019738

§ 371 Date: Sep. 15, 2025

(30) Foreign Application Priority Data
Dec. 30, 2022 (KR) 10-2022-0190774

(51) Int. Cl. F16D 3/12; F16D 3/14; F16D 3/66; F16D 127/00

(52) U.S. Cl. CPC F16D 3/12; F16D 3/14; F16D 3/66; F16D 2127/00; F16D 2300/22

(57) ABSTRACT

A multi-stage vibration damping apparatus includes: a first damping unit including a first input member, a first output member, and a first spring; a second damping unit including a second input member, a second output member, and a second spring, the second damping unit being arranged axially outward of the first damping unit; and a rotor unit including a rotor sleeve. The first input member is fixed to the rotor sleeve radially outward of the first spring.

### TECHNICAL FIELD

The present invention relates to a vibration damping apparatus for vehicles, particularly for hybrid vehicles, and more specifically, to a multi-stage vibration damping apparatus including hysteresis regulating means.

### BACKGROUND

A power transmission device for hybrid vehicles is known in which a motor is installed inside a transmission and a vibration damping apparatus is arranged radially inward of the motor. A torsional damper, also referred to as a torsional vibration damper, may connect two or more dampers in series to improve engine vibration absorption performance. The torsional damper may be located inside the transmission and use transmission oil as a lubricant.

Korean Patent No. 10-2238845, entitled “Power Transmission Device for Hybrid Vehicles,” discloses, as shown in FIG. 1, a power transmission device 1 arranged between an engine 2 located on the right side of the drawing and a transmission 3 located on the left side of the drawing. The power transmission device 1 includes a torsional damper 40, and the torsional damper 40 includes two damper units 41 and 42. Referring to the enlarged view at the bottom of FIG. 1, a rotor sleeve P11 is coupled to a rotor P10 arranged on the engine 2 side, and a driven plate P40 is arranged on the transmission 3 side.

A primary torsional damper 42 includes a cover plate P20 and a spring P21, and a driven plate P23 is positioned inside thereof. The cover plate P20 of the primary torsional damper 42 is welded to the rotor sleeve P11 at a fixed portion P25. A secondary torsional damper 41 includes a front cover plate P30 and a spring P31. Within the secondary torsional damper, hysteresis regulating members P35a and P35b, such as friction washers or elastic washers, are arranged on both sides of the driven plate P40. Hysteresis refers to an elastic hysteresis phenomenon.

In the torsional damper configuration described above, particularly during idle operation, components constituting the primary and/or secondary torsional damper may move in the axial direction or radial direction, often generating rattling noise referred to as idle noise. The hysteresis regulating member P35 is provided to suppress such idle noise.

In the above conventional technology, since the hysteresis regulating member P35 is provided only on the secondary torsional damper 41 side, it is difficult to effectively suppress idle noise of the primary torsional damper 42.

To reliably suppress idle noise of the vibration damping apparatus, hysteresis regulating members need to be arranged at required positions. However, it is considerably difficult to additionally arrange such members because other components of the hybrid vehicle's vibration damping apparatus are already densely arranged within a limited space.

In addition, in the conventional configuration, the fixed portion P25 between the cover plate P20 of the primary torsional damper 42 and the rotor sleeve P11 is located radially inward from the center of the torsional damper 40, in other words, positioned radially inward of the spring P21 of the primary torsional damper. When the torsional damper 40 rotates, its components tend to move radially outward due to centrifugal force. Since the fixed portion P25 is located radially inward, it does not firmly hold such outward movement tendencies, making it difficult to effectively suppress overall idle noise of the torsional damper 40.

### SUMMARY OF THE INVENTION

### Problem to be Solved

The present invention aims to provide a multi-stage vibration damping apparatus capable of eliminating axial and radial movements of the damper and abnormal spring behavior resulting therefrom.

The present invention also aims to provide a multi-stage vibration damping apparatus capable of preventing breakage of the spring due to abnormal torque of the engine.

The present invention also aims to provide a multi-stage vibration damping apparatus capable of preventing axial and/or radial movements of the damper and/or breakage of the spring while maintaining the compactness of a conventional damper.

The problems to be solved by the present invention are not limited to the problems mentioned above, and other problems not mentioned will be clearly understood by those skilled in the art from the following description.

### Solution to Solve Problem

In order to achieve the above-described objects, a vibration damping apparatus according to the present invention includes the following aspects and any combinations thereof.

One aspect of the present invention provides a vibration damping apparatus comprising: a first damping unit including a first input member, a first output member, and a first spring; a second damping unit including a second input member, a second output member, and a second spring, the second damping unit being arranged axially outward of the first damping unit; and a rotor unit including a rotor sleeve, wherein the first input member is coupled to the rotor sleeve radially outward of the first spring.

Another aspect of the present invention provides a vibration damping apparatus wherein the first spring includes an outer spring and an inner spring inserted inside the outer spring, and the first input member is coupled to the rotor sleeve radially outward of either the outer spring or the inner spring of the first spring.

Another aspect of the present invention provides a vibration damping apparatus wherein the first input member is coupled to the rotor sleeve radially outward of a center of the first spring.

Another aspect of the present invention provides a vibration damping apparatus further comprising hysteresis regulating means arranged in the axial direction at a forward side and/or a rearward side of the first output member.

Another aspect of the present invention provides a vibration damping apparatus further comprising hysteresis regulating means arranged in the axial direction at a forward side and/or a rearward side of the second output member.

Another aspect of the present invention provides a vibration damping apparatus wherein the hysteresis regulating means includes at least one selected from the group consisting of a friction washer, a metal washer, and an elastic washer.

Another aspect of the present invention provides a vibration damping apparatus wherein the first input member is a cover plate, and the second input member is a front cover plate.

Another aspect of the present invention provides a vibration damping apparatus wherein the first and second output members are respectively driven plates.

Another aspect of the present invention provides a vibration damping apparatus wherein the first output member and the second input member are coupled to be fixed to each other in a rotational direction.

Another aspect of the present invention provides a vibration damping apparatus further comprising a mechanical stopper configured to limit relative rotation between the first input member and the second input member within a predetermined range.

Another aspect of the present invention provides a vibration damping apparatus wherein the first input member has a central hole, and the mechanical stopper includes a first protrusion protruding radially inward from the first input member toward the central hole, and a second protrusion protruding axially inward from the second input member toward the first input member, wherein the first protrusion and the second protrusion are configured to interfere with each other when the first input member or the second input member rotates.

Another aspect of the present invention provides a vibration damping apparatus further comprising hysteresis regulating means arranged rearward in the axial direction of the first output member, wherein the hysteresis regulating means has a circumferential groove so as not to interfere with the second protrusion.

Another aspect of the present invention provides a vibration damping apparatus wherein the mechanical stopper includes a first protrusion protruding axially inward from the first input member toward the first output member, wherein the first protrusion and the first output member are configured to interfere with each other when the first input member or the first output member rotates.

Another aspect of the present invention provides a vibration damping apparatus further comprising hysteresis regulating means arranged forward and/or rearward in the axial direction of the first output member.

Another aspect of the present invention provides a vibration damping apparatus wherein at least one of the hysteresis regulating means includes a groove into which the first protrusion is insertable.

Another aspect of the present invention provides a vibration damping apparatus wherein a second protrusion protruding axially forward and/or rearward from the first output member is formed, and at least one of the hysteresis regulating means includes a groove into which the second protrusion is insertable.

### Effects of the Invention

According to the present invention, idle noise of the multi-stage vibration damping apparatus can be more effectively suppressed while maintaining a compact design.

According to the present invention, breakage of the spring due to abnormal behavior of the engine can be prevented while maintaining a compact design.

The effects of the present invention are not limited to the effects mentioned above, and other effects not mentioned will be clearly understood by those skilled in the art from the following description.

### BRIEF DESCRIPTION OF THE DRAWINGS

The following description will be better understood when read in conjunction with the accompanying drawings. Components having the same reference numerals in different drawings have similar functions and will not be repeatedly described unless necessary for understanding the invention, and known components may be briefly described or omitted but should not be construed as being excluded from the embodiments of the present invention.

FIG. 1 is a schematic view of a power transmission device for a hybrid vehicle having a vibration damping apparatus according to the prior art of the present invention.

FIG. 2 is a perspective view of a vibration damping apparatus according to an embodiment of the present invention.

FIG. 3 is a rear view of a vibration damping apparatus according to an embodiment of the present invention.

FIG. 4 is a perspective view of a cover plate according to an embodiment of the present invention.

FIG. 5 is a perspective view of a front cover plate according to an embodiment of the present invention.

FIG. 6 shows a state in which the cover plate of FIG. 4 and the front cover plate of FIG. 5 are overlapped.

FIG. 7 is a perspective view of a driven plate according to an embodiment of the present invention.

FIG. 8 is a perspective view of another driven plate according to an embodiment of the present invention.

FIG. 9 is a perspective view of a friction washer and a metal washer according to an embodiment of the present invention.

FIG. 10 is a perspective view of an elastic washer according to an embodiment of the present invention.

FIG. 11A is a perspective view of another friction washer according to an embodiment of the present invention.

FIG. 11B is a cross-sectional perspective view of the friction washer shown in FIG. 11A.

FIG. 12 is a perspective view of yet another friction washer according to an embodiment of the present invention.

FIG. 13 is a half-sectional view of a vibration damping apparatus according to an embodiment of the present invention.

FIG. 14 is a partially enlarged perspective view of FIG. 13.

FIG. 15 is a conceptual diagram regarding the arrangement state of the spring, hysteresis regulating means, and mechanical stopper according to the present invention.

FIG. 16A is a schematic diagram showing the arrangement state of the spring, hysteresis regulating means, and mechanical stopper according to an embodiment of the present invention.

FIG. 16B is a schematic diagram showing the arrangement state of the spring, hysteresis regulating means, and mechanical stopper according to another embodiment of the present invention.

FIG. 17 is a schematic diagram showing the arrangement state of the spring, hysteresis regulating means, and mechanical stopper according to yet another embodiment of the present invention.

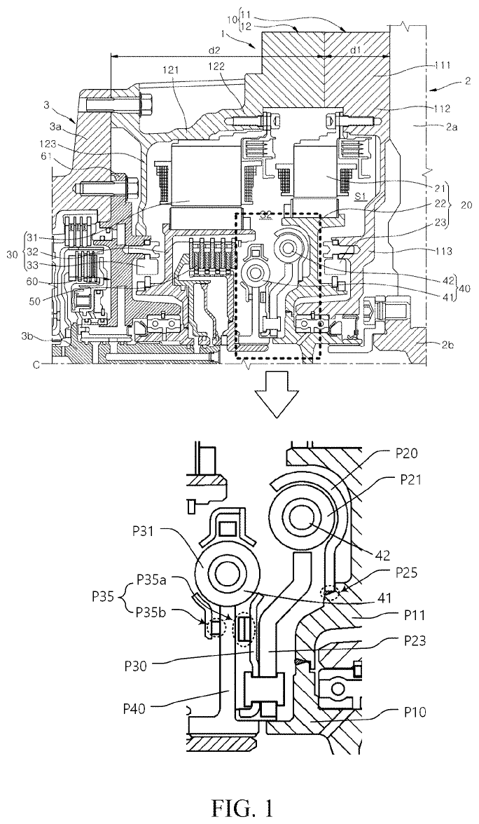

### DETAILED DESCRIPTION OF THE INVENTION

The present invention is not limited to the embodiments disclosed below but may be variously modified and implemented in different forms. The embodiments are provided merely to make the disclosure of the present invention complete and to fully convey the scope of the invention to those skilled in the art. Accordingly, the present invention is not limited to the embodiments disclosed below, and substitutions or additions between the configurations of one embodiment and another are possible. It should also be understood that all modifications, equivalents, and alternatives included within the spirit and scope of the present invention are encompassed.

The accompanying drawings are provided only to facilitate understanding of the embodiments disclosed in this specification, and the technical idea disclosed herein is not limited by the accompanying drawings. It should be understood that all modifications, equivalents, and alternatives included within the spirit and scope of the present invention are encompassed. In the drawings, components may be illustrated larger or smaller in size or thickness for convenience of understanding; however, the protection scope of the present invention should not be interpreted narrowly due to such illustration.

The terms used in this specification are merely for the purpose of describing particular embodiments and are not intended to limit the present invention. The singular expressions include plural expressions unless the context clearly dictates otherwise. The terms such as “comprising” and “including” used in the specification are intended to specify that the features, numbers, steps, actions, components, parts, or combinations thereof described in the specification are present. That is, the terms such as “comprising” and “including” should be understood not to preclude the presence or addition of one or more other features, numbers, steps, actions, components, parts, or combinations thereof.

Terms including ordinal numbers such as first and second may be used to describe various components but are not limited by such terms. The terms are used only to distinguish one component from another.

When a component is said to be “connected” or “coupled” to another component, it should be understood that it may be directly connected or coupled to the other component or indirectly connected or coupled through another component. In contrast, when a component is said to be “directly connected” or “directly coupled” to another component, it should be understood that there are no other components in between.

When a component is said to be “on” or “above” or “under” or “below” another component, it should be understood that it is not only arranged immediately on or under the other component but also that other components may be interposed in between.

Unless otherwise defined, all terms used herein, including technical or scientific terms, have the same meaning as commonly understood by those skilled in the art to which the present invention pertains. Terms defined in generally used dictionaries should be interpreted as having meanings consistent with the context of the related technology, and unless explicitly defined in this specification, they should not be interpreted in an idealized or excessively formal sense.

Since the assembly of the embodiment is symmetrical about an axis, only half thereof may be illustrated along the axis for convenience of drawing. Also, for convenience of description, a direction along the length of the axis forming the center of rotation of the assembly is referred to as the axial direction. In other words, the forward/rearward direction or axial direction means a direction parallel to the rotational axis. The forward direction refers to one direction toward a power source, for example, toward a vehicle drive motor, and the rearward direction refers to the other direction, for example, toward a transmission. Accordingly, the front face refers to a surface facing forward, and the rear face refers to a surface facing rearward.

The radial direction is a direction that approaches or moves away from the center of the rotational axis along a straight line passing through the center on a plane perpendicular to the rotational axis. The direction moving radially outward from the center is called the centrifugal direction, and the direction approaching the center is called the centripetal direction.

The circumferential direction is a direction surrounding the rotational axis. The outer circumference refers to the outer periphery, and the inner circumference refers to the inner periphery. Accordingly, the outer circumferential surface is a surface facing away from the rotational axis, and the inner circumferential surface is a surface facing toward the rotational axis. The circumferential side surface is a surface whose normal faces in the circumferential direction.

In the present invention, axially inward means a position closer to the engine side in the axial direction, and axially outward means a position farther from the engine side in the axial direction.

Hereinafter, the present invention will be described in detail with reference to the accompanying drawings.

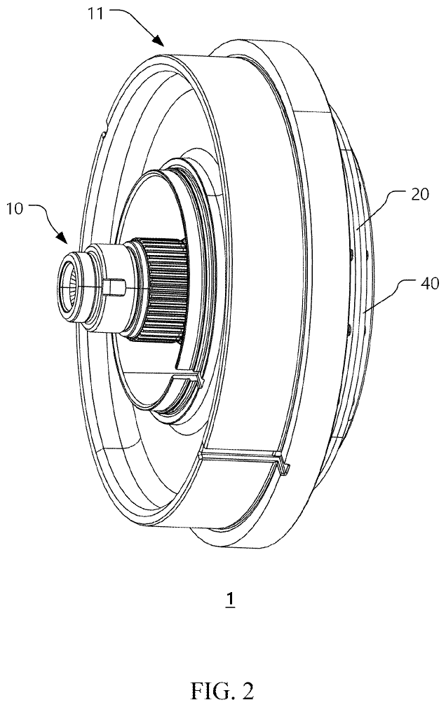

Referring first to FIG. 2, according to an embodiment of the present invention, a vibration damping apparatus 1 including a rotor shaft 10, a rotor sleeve 11, cover plates 20 and 40, and the like is shown. In the present invention, the vibration damping apparatus may also be referred to as a rotor and damper assembly. The term “multi-stage” vibration damping apparatus means including two or more dampers connected in series, and in the illustrated embodiment, a vibration damping apparatus having two dampers is exemplified. Hereinafter, the damper located axially inward is referred to as a first damper, and the damper located axially outward is referred to as a second damper.

The vibration damping apparatus according to the present invention is preferably used for installation radially inward of a motor inside a hybrid vehicle transmission.

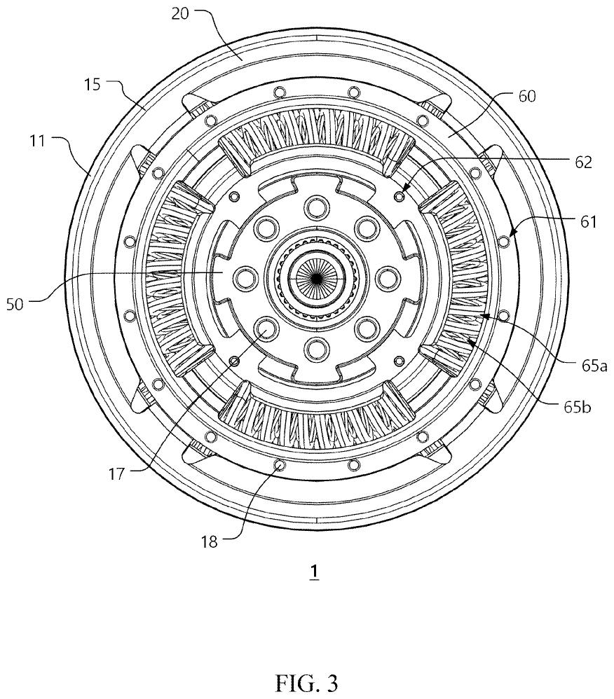

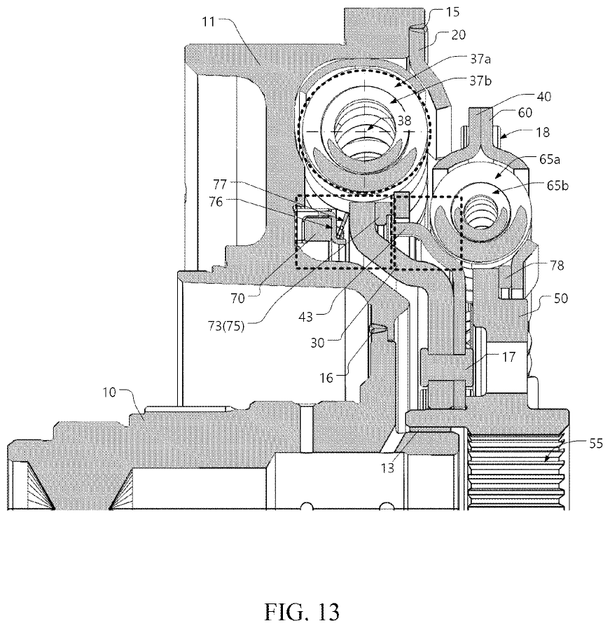

Referring to FIG. 3, which is a rear view of FIG. 2, a fixed portion 15, for example, a welded portion, between the rotor sleeve 11 and the cover plate 20 is shown. A rear cover plate 60 has coupling holes 61 and washer holes 62. Rivets 18 are inserted into the coupling holes 61 to couple the rear cover plate 60 and the front cover plate 40 (see FIG. 13). An outer spring 65a and an inner spring 65b are accommodated inside the rear cover plate 60. A total of four sets of springs 65a and 65b are arranged in the circumferential direction. A driven plate 50 is arranged inside the second damper. Rivets 17 couple a driven plate 30 arranged in the first damper and the front cover plate 40 of the second damper (see FIG. 13). By such rivet coupling, the two members are fixed not only in the axial direction but also in the rotational direction, so they always rotate together.

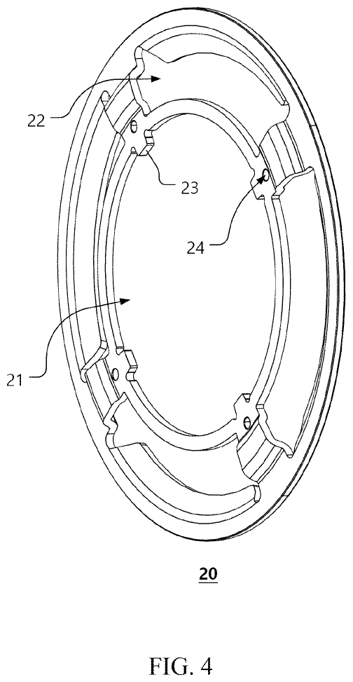

FIG. 4 shows the cover plate 20 according to an embodiment of the present invention. This constitutes the first damper together with the driven plate 30 and springs 37a and 37b described later, and serves as the input member of the first damper. That is, it is fixed to the rotor sleeve and functions to transmit driving force from the engine.

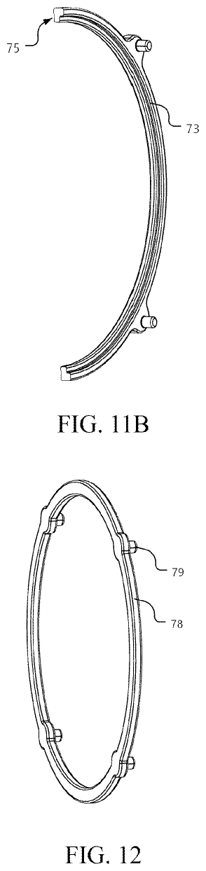

The cover plate 20 has an overall ring shape and includes a central hole 21 for insertion of the rotor shaft 10 and the like, a spring accommodating space 22, and washer holes 24. Into the washer holes 24, engaging protrusions 74 of a friction washer 73 described later (see FIG. 11A) are fitted.

The cover plate 20 may have keys 23 protruding radially inward toward the central hole 21. In this example, a total of four radial keys 23 are provided.

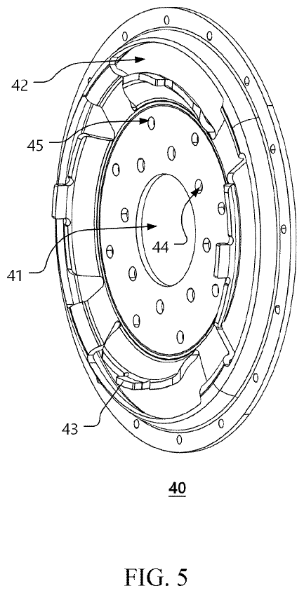

FIG. 5 shows the front cover plate 40 according to an embodiment of the present invention. This constitutes the second damper together with the driven plate 50, the rear cover plate 60, and springs 65a and 65b described later, and serves as the input member of the second damper. That is, it is coupled to the driven plate 30, which is the output member of the first damper, and functions to transmit driving force.

The front cover plate 40 includes a central hole 41 for insertion of the rotor shaft 10 and the like, a spring accommodating space 42, coupling holes 44, and oil flow holes 45. The coupling holes 44 are holes formed inward near the central hole 41 for rivet coupling with the driven plate 30 described later. The oil flow holes 45 are holes formed radially outward of the coupling holes 44 for the flow of lubricating oil, such as automatic transmission fluid (ATF).

The front cover plate 40 may have keys 43 protruding in the axial direction. In this example, a total of four axial keys 43 are provided.

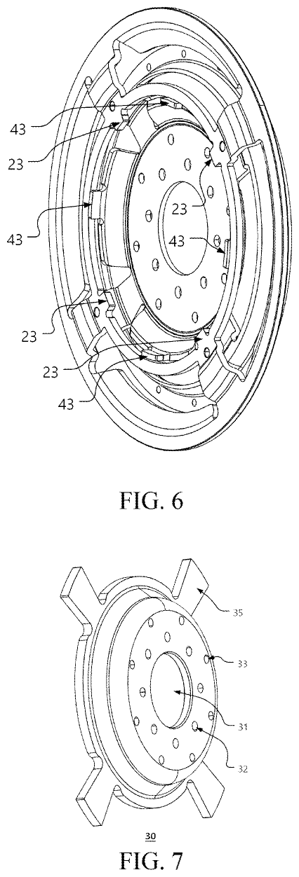

FIG. 6 shows the cover plate 20 shown in FIG. 4 and the front cover plate 40 shown in FIG. 5 in an overlapped state, which is the same as the arrangement after assembly. The two members are rotatable relative to each other. As is clear from the illustration, when either one of the two members rotates, the radial keys 23 and the axial keys 43 are configured to collide with each other. This collision phenomenon is referred to as “interference.”

The cover plate 20, which is the input member of the first damper, transmits power to the driven plate 30 and the front cover plate 40 coupled therewith through the springs 37a and 37b. When an excessive torque is generated from the engine, the springs 37a and 37b may be excessively compressed and broken. The configuration in which the radial keys 23 and the axial keys 43 interfere with each other limits the relative rotation between the cover plate 20 and the front cover plate 40 within a predetermined range. In other words, over-rotation of the input member, the cover plate 20, is prevented, and over-compression of the springs 37a and 37b can be prevented.

FIG. 7 shows the driven plate 30 of the first damper according to an embodiment of the present invention. The driven plate 30 includes a central hole 31 formed in its center, coupling holes 32 into which coupling members such as rivets can be inserted, and oil flow holes 33 for the flow of lubricating oil, such as automatic transmission fluid (ATF). The series of holes formed closer to the center of the driven plate 30 are the coupling holes 32, and the series of holes formed farther away are the oil flow holes 33. The central hole 31 is a hole into which the rotor shaft 10 is inserted. The driven plate 30 functions as the output member of the first damper, receiving power from the springs through a blade portion 35.

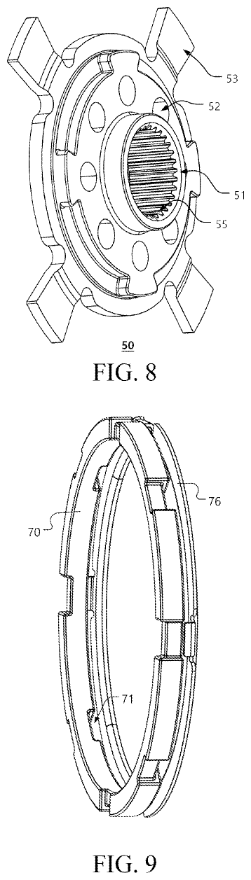

FIG. 8 shows the driven plate 50 functioning as the output member of the second damper according to an embodiment of the present invention. The driven plate 50 includes a central hole 51 having a spline portion 55 and through holes 52. The through holes 52 can function as passages for inserting rivets 17 to rivet the driven plate 30 and the front cover plate 40 when the second damper is assembled. The driven plate 50 also has blades 53.

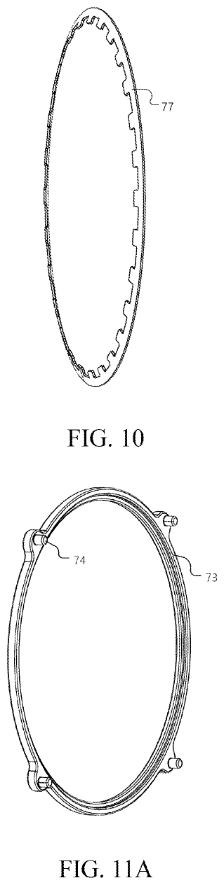

FIGS. 9 and 10 show friction washers 70, metal washers 76, and elastic washers 77, which are hysteresis regulating members according to an embodiment of the present invention. The friction washer 70 is provided with oil flow grooves 71.

FIGS. 11A and 11B show another friction washer 73 according to an embodiment of the present invention. The friction washer 73 has an engaging protrusion 74 fitted into the washer hole 24 of the cover plate 20. The friction washer 73 may include a circumferential groove so as not to interfere with the axial keys 43. Accordingly, the upper cross section 75 may have an “r” shape.

FIG. 12 shows yet another friction washer 78 according to an embodiment of the present invention. The friction washer 78 has an engaging protrusion 79 fitted into the washer hole 62 of the rear cover plate 60.

FIG. 13 shows a half-sectional view of a vibration damping apparatus according to an embodiment of the present invention. First, the left side of FIG. 13 is the engine side, and the right side is the transmission side. The rotor is composed of a rotor shaft 10 and a rotor sleeve 11, and to the right thereof, a first damper including the driven plate 30, outer spring 37a, inner spring 37b, and cover plate 20 is arranged. A total of four sets of springs 37a and 37b may be arranged in the circumferential direction. To the right thereof, a second damper including the front cover plate 40, outer spring 65a, inner spring 65b, driven plate 50, and rear cover plate 60 is arranged. The driven plate 30 and the front cover plate 40 are coupled to each other by rivets 17. A bushing 13 is also provided on the sliding face of the rotor shaft 10.

A fixed portion 16 is formed between the rotor shaft 10 and the rotor sleeve 11, and a fixed portion 15 is formed between the rotor sleeve 11 and the cover plate 20. The fixed portions 15 and 16 may be welded portions.

Friction washer 70, metal washer 76, and elastic washer 77 are arranged on the left side, i.e., the forward side, of the driven plate 30. Since the friction washer 70 is pressed toward the inner wall of the rotor sleeve 11 by the elastic washer 77, it can rotate together with the rotor sleeve 11 when the rotor sleeve 11 rotates.

Friction washer 73 is arranged on the right side, i.e., the rear side, of the driven plate 30. Since the engaging protrusion 74 of the friction washer 73 is fitted into the cover plate 20, it can rotate together with the cover plate 20.

Similarly, friction washer 78 is arranged on the right side, i.e., the rear side, of the driven plate 50, and it is coupled to the rear cover plate 60 by the engaging protrusion 79, so it rotates together with the rear cover plate 60.

As described above, in the vibration damping apparatus according to the present invention, hysteresis regulating means can be provided not only on the second damper side but also on the first damper side, so that axial movement of the components constituting the first damper can be suppressed.

Positioning the fixed portion 15 radially outward is advantageous for hysteresis regulation, i.e., idle noise suppression, as it firmly holds the radial outward movement of the vibration damping apparatus. By forming the fixed portion 15 radially outward of the components constituting the vibration damping apparatus, the tendency of the components to move outward due to centrifugal force can be stably restrained. Specifically, it is preferable that the fixed portion 15 be positioned radially outward of the springs 37a and 37b of the first damper.

Furthermore, positioning the fixed portion 15 also axially outward of the springs 37a and 37b of the first damper, i.e., between the first damper and the second damper, can be advantageous for hysteresis regulation.

The springs of the first damper may have a dual spring structure including the outer spring 37a and the inner spring 37b inserted therein. The center 38 of the springs is the same for the outer spring 37a and the inner spring 37b.

When the rotor rotates by engine driving, the cover plate 20 fixed to the rotor sleeve 11 rotates, and vibration is primarily damped by the springs 37a and 37b of the first damper. If the vibration amplitude exceeds the elastic force of the first damper, the driven plate 30 rotates, and as the front cover plate 40 of the second damper fixed to the driven plate 30 rotates together, secondary damping is performed by the springs 65a and 65b of the second damper.

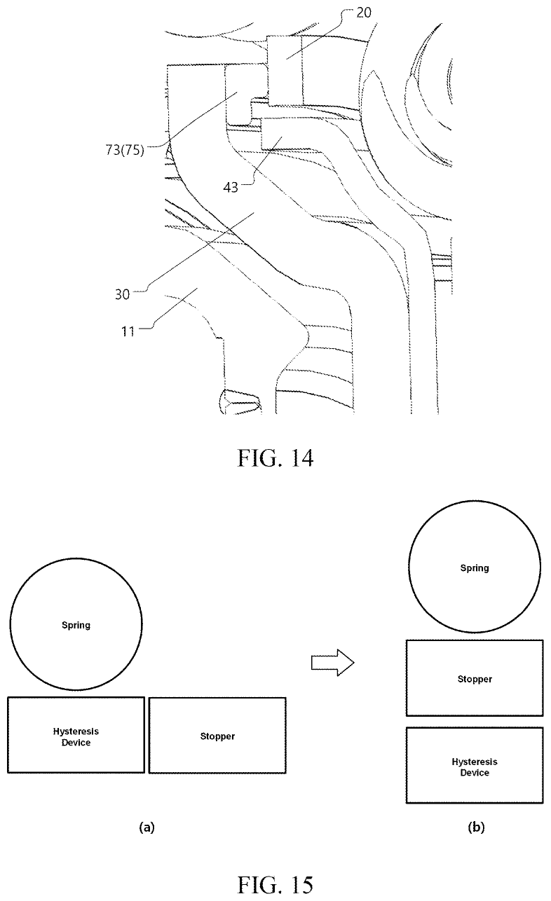

Referring to FIG. 14, the cross section 75 of the friction washer 73 arranged on the right side of the driven plate 30 has an “r” shape to avoid interference with the axial keys 43.

As described above, the inventors of the present invention have discovered that idle noise can be effectively suppressed by forming the fixed point between the vibration damping unit having a plurality of torsional dampers and the rotor sleeve radially or axially outward of the springs of the first damper and providing hysteresis regulating members in front of and/or behind the output member of the first torsional damper.

FIGS. 15 to 17 schematically show arrangement states of springs, hysteresis regulating means, and mechanical stoppers according to embodiments of the present invention.

FIG. 15(a) shows the arrangement state of the springs, hysteresis members, and mechanical stopper in the embodiment illustrated in FIG. 13. It corresponds to the circle and rectangles indicated by dotted lines in FIG. 13. Compared to this arrangement, as shown in (b), if the three elements are arranged in a row in the radial direction, a more compact configuration in the axial direction can be achieved. The axial space secured in this way can increase design flexibility.

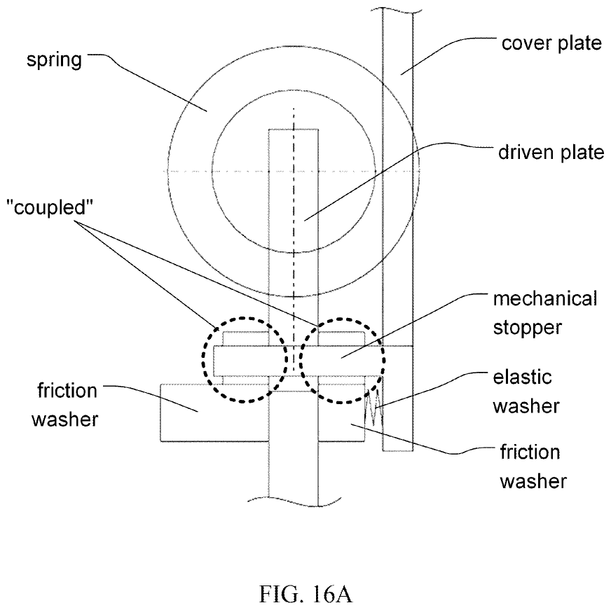

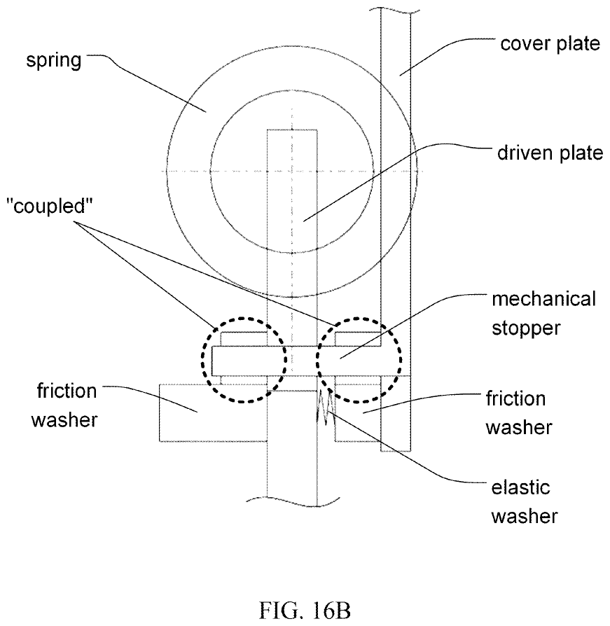

Referring to FIGS. 16A and 16B, instead of the keys 43 extending axially from the front cover plate of the second damper, keys (mechanical stoppers) protruding axially inward from the cover plate of the first damper are provided. The mechanical stopper interferes with the driven plate (e.g., its blade) so that over-rotation of the cover plate of the first damper is prevented, thereby preventing over-compression of the springs.

The friction washers on the left and right sides of the driven plate are provided with key grooves into which the mechanical stoppers are inserted, and are coupled to the mechanical stoppers. Therefore, they can rotate together. The elastic washer may be arranged axially outward (FIG. 16A) or axially inward (FIG. 16B) of the right friction washer. In this way, the springs, hysteresis members, and mechanical stopper can be arranged in a row in the radial direction.

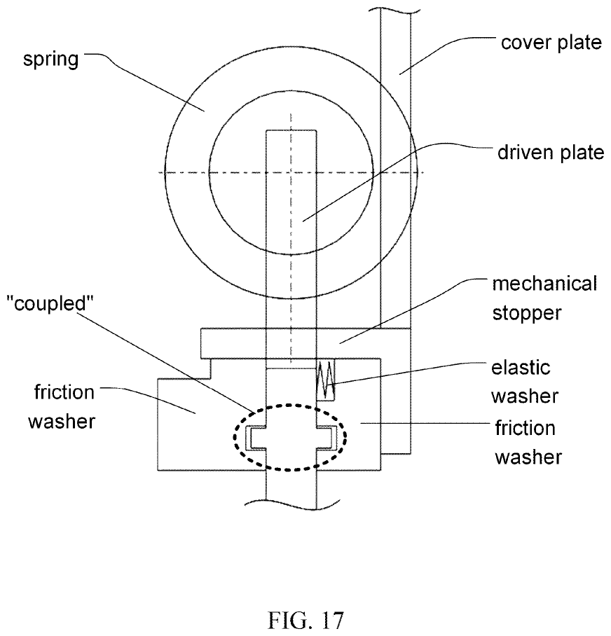

In FIG. 17, similarly to FIGS. 16A and 16B, a mechanical stopper protruding axially inward from the cover plate of the first damper is provided, but both friction washers are provided with key grooves engaging with keys protruding from the driven plate, so that the friction washers and the driven plate can rotate together. The elastic washer is arranged radially inward of the right friction washer. This is also a configuration in which the springs, hysteresis members, and mechanical stopper are arranged in a row in the radial direction.

In this regard, the embodiment shown in FIGS. 6 and 13 has a configuration in which the input member of the second damper (i.e., the front cover plate 40) prevents over-rotation of the input member of the first damper (i.e., the cover plate 20), whereas in the embodiments shown in FIGS. 16A, 16B, and 17, the output member of the first damper (i.e., the driven plate 30) interferes with the rotation of the input member of the first damper. As described above, since the input member of the second damper rotates integrally with the output member of the first damper, the same result can be obtained whether either of the two members interferes with the rotation of the input member of the first damper.

As described above, the inventors of the present invention have presented a method of realizing a more compact vibration damping apparatus structure by optimizing the arrangement of the springs, stoppers, and hysteresis members.

While the embodiments of the present invention have been described above with reference to the accompanying drawings, those skilled in the art to which the present invention pertains will understand that the present invention can be implemented in other specific forms without changing its technical idea or essential features. Therefore, the above-described embodiments should be understood as illustrative rather than limiting. The protection scope of the present invention should be interpreted according to the following claims, and all technical ideas within equivalent scope should be interpreted as included in the protection scope of the present invention.

1. A vibration damping apparatus comprising:
a first damping unit including a first input member, a first output member, and a first spring;
a second damping unit including a second input member, a second output member, and a second spring, the second damping unit being arranged axially outward of the first damping unit; and
a rotor unit including a rotor sleeve,
wherein the first input member is coupled to the rotor sleeve radially outward of the first spring.

2. The vibration damping apparatus according to claim 1,
wherein the first spring includes an outer spring and an inner spring inserted inside the outer spring,
and the first input member is coupled to the rotor sleeve radially outward of either the outer spring or the inner spring of the first spring.

3. The vibration damping apparatus according to claim 1,
wherein the first input member is coupled to the rotor sleeve radially outward of a center of the first spring.

4. The vibration damping apparatus according to claim 1,
further comprising hysteresis regulating means arranged in the axial direction at a forward side and/or a rearward side of the first output member.

5. The vibration damping apparatus according to claim 4,
further comprising hysteresis regulating means arranged in the axial direction at a forward side and/or a rearward side of the second output member.

6. The vibration damping apparatus according to claim 4,
wherein the hysteresis regulating means includes at least one selected from the group consisting of a friction washer, a metal washer, and an elastic washer.

7. The vibration damping apparatus according to claim 1,
wherein the first input member is a cover plate, and the second input member is a front cover plate.

8. The vibration damping apparatus according to claim 1,
wherein the first and second output members are respectively driven plates.

9. The vibration damping apparatus according to claim 1,
wherein the first output member and the second input member are coupled to be fixed to each other in a rotational direction.

10. The vibration damping apparatus according to claim 1,
further comprising a mechanical stopper configured to limit relative rotation between the first input member and the second input member within a predetermined range.

11. The vibration damping apparatus according to claim 10,
wherein the first input member has a central hole,
and the mechanical stopper includes:
a first protrusion protruding radially inward from the first input member toward the central hole; and
a second protrusion protruding axially inward from the second input member toward the first input member,
wherein the first protrusion and the second protrusion are configured to interfere with each other when the first input member or the second input member rotates.

12. The vibration damping apparatus according to claim 11,
further comprising hysteresis regulating means arranged rearward in the axial direction of the first output member,
wherein the hysteresis regulating means has a circumferential groove so as not to interfere with the second protrusion.

13. The vibration damping apparatus according to claim 10,
wherein the mechanical stopper includes a first protrusion protruding axially inward from the first input member toward the first output member,
wherein the first protrusion and the first output member are configured to interfere with each other when the first input member or the first output member rotates.

14. The vibration damping apparatus according to claim 13,
further comprising hysteresis regulating means arranged forward and/or rearward in the axial direction of the first output member.

15. The vibration damping apparatus according to claim 14,
wherein at least one of the hysteresis regulating means includes a groove into which the first protrusion is insertable.

16. The vibration damping apparatus according to claim 14,
wherein a second protrusion protruding axially forward and/or rearward from the first output member is formed,
and at least one of the hysteresis regulating means includes a groove into which the second protrusion is insertable.

17. The vibration damping apparatus according to claim 5,
wherein the hysteresis regulating means includes at least one selected from the group consisting of a friction washer, a metal washer, and an elastic washer.
